(19) United States
(12) Patent Application Publication
(10) Pub. No.: US 2012/0243232 A1
(43) Pub. Date: Sep. 27, 2012

(54) Lighting module

(75) Inventors: Ralph Bertram, Nittendorf (DE); Robert Kraus, Regensburg (DE); Stefan Lorenz, Obertraubling (DE); Peter Sachsenweger, Zeitlarn (DE); Simon Schwalenberg, Donaustauf (DE)

(73) Assignee: OSRAM AG, Muenchen (DE)

(21) Appl. No.: 13/513,199

(22) PCT Filed: Nov. 15, 2010
(86) PCT No.: PCT/EP2010/067470

§ 371 Date: Jun. 1, 2012

(30) Foreign Application Priority Data
Dec. 4, 2009 (DE) 10 2009 047 489.7

(51) Int. Cl. F21V 29/00

(52) U.S. Cl. 362/249.02; 362/249.01

(57) ABSTRACT

A lighting module may include a printed-circuit board which via its rear side is positioned on a cooling body and on its front side is fitted with at least one light source, and at least one electronic component; a cover for at least a partial region of the printed-circuit board, with the cover being seated upon the printed-circuit board; wherein the lighting module has at least one elastic fastening element which is secured to the cooling body and positioned against the cover.

The invention relates to a lighting module having a printed-circuit board which via its rear side is positioned on a cooling body and on its front side is fitted with at least one light source and at least one electronic component, and having a cover (housing) for at least a partial region of the printed-circuit board, with the cover being seated upon the printed-circuit board.

The cover, printed-circuit board, and cooling body have in lighting modules of the kind cited in the introduction hitherto been joined together by means of metal screws, with one screw projecting through the cover and printed-circuit board and being secured into position in the cooling body. The cover is screwed to the cooling body thereby and the printed-circuit board pressed in place between them. Known also is a use of sleeves in combination with screws. A disadvantage of lighting modules of such kind is their association with possible mounting and/or component tolerances and consequent thermal losses. Other tolerances, gaps for example, may also arise owing to heat dissipated by the at least one light source and at least one electronic component. Thus screws, for example, can undergo greater expansion during heating than a plastic housing, as a result of which the cover may even lift from the printed-circuit board. Screws and sleeves furthermore require installation space on the printed-circuit board, which may pose problems in terms of a shortening of electric leakage paths inside the lighting module.

The object of the present invention is to provide a lighting module that will eliminate or alleviate at least some of the existing disadvantages, and in particular to provide a lighting module that is mechanically less sensitive to thermal stress and can save installation space and manage with simple means without a shortening of leakage paths.

Said object is achieved according to the features of the independent claims. Preferred embodiment variants are described particularly in the dependent claims.

The object is achieved by means of a lighting module having a printed-circuit board which via its rear side is positioned on a cooling body and on its front side is fitted with at least one light source and at least one electronic component, and having a cover for at least a partial region of the printed-circuit board, with the cover being seated upon the printed-circuit board.

The at least one light source preferably includes at least one light-emitting diode. If provided, a plurality of light-emitting diodes can shine in the same color or in different colors. A color can be monochromatic (for example red, green, blue etc.) or multichromatic (white, for instance). The light emitted by the at least one light-emitting diode light can also be an infrared light (IR LED) or an ultraviolet light (UV LED). A plurality of light-emitting diodes can produce a mixed light, for example a white mixed light. The at least one light-emitting diode can contain at least one wavelength-converting luminescent substance (conversion LED). The at least one light-emitting diode can be in the form of at least one individually housed light-emitting diode or in the form of at least one LED chip. A plurality of LED chips can be mounted on a common substrate (“submount”). The at least one light-emitting diode can be fitted with at least one separate and/or common optic for beam guiding, for example at least one Fresnel lens or collimator and so forth. Instead of or in addition to inorganic light-emitting diodes based on, for example, InGaN or AlInGaP, it is generally also possible to employ organic LEDs (OLEDs, for example polymer OLEDs). Diode lasers, for example, can also be used. The at least one light source can alternatively have, for example, at least one diode laser.

An electronic component may include, for example, a resistor, a capacitor, and/or an integrated circuit, for example for use as a driver for the at least one light source.

The lighting module furthermore has at least one elastic fastening element which is secured to the cooling body and positioned against the cover. The fastening element is consequently located outside the cover so that no installation space will have to be provided for it on the board. Nor, therefore, will any leakage paths have to be shortened, or no problems will arise owing to a shortening of leakage paths. Moreover, the fastening element will not become very hot because the heat that enters is effectively ducted away via the link to the cooling body. A pressure acting upon the cover can hence be maintained even under changing thermal-stress conditions, as a result of which tolerances can be effectively compensated. In other words, tolerances arising as a result of component heating, for example, can be equalized owing to the fastening element's elastic properties. Component fatigue, thermally induced deformation, and material ageing can also be at least partially compensated thereby. A pressure acting upon the printed-circuit board throughout its service life will in turn impact advantageously on the efficiency of the light source(s).

In one embodiment the cover has an outward, particularly upward projection (“edge enhancement”) at least in a region in which the cover is vaulted by the at least one fastening element. That can prevent the fastening element's slipping out of place and the cover's sliding out of position from under the fastening element, which can occur when the cover is subjected to a mechanical stress for example.

In another embodiment the at least one fastening element is kept under tension even when not thermally stressed. The cover and printed-circuit board can thereby be kept continuously under pressure. The at least one fastening element can alternatively be substantially tension-free when not thermally stressed (initial condition).

In yet another embodiment the at least one fastening element is applied to the cover's top side. The at least one fastening element can thereby be easily placed on the cover.

In a further embodiment the at least one fastening element is screwed onto the cooling body. Thermal stressing of the fastening element can be kept low thereby. The cooling body can simultaneously provide a sufficiently large and easily accessible mounting surface.

In a development, the lighting module has precisely one elastic fastening element. The elastic fastening element can be used in combination with at least one other fastening means, for example a screw, for fixing the cover and printed-circuit board to the cooling body. In particular a screw can be used for pressing the cover and hence the printed-circuit board onto the cooling body and preventing the printed-circuit board and cover from undergoing a translational motion. Tolerance equalizing can be performed by the one elastic fastening element and a rotational motion can be suppressed.

The lighting module can alternatively have a plurality of elastic fastening elements, specifically on their own or in combination with at least one other fastening means, for example a screw. Improved tolerance compensating can be achieved through the plurality of elastic fastening elements and a displacement between the cover and printed-circuit board more effectively suppressed. Also along with the at least one other fastening means, the plurality of fastening elements can be attached to the cover substantially symmetrically, in particular rotationally symmetrically. A particularly even compressive load can in that way be exerted on the cover.

In a further embodiment the fastening element is located at least partially in a region formed by a common lateral recess in the printed-circuit board and cover. The lighting module's installation space can be further reduced thereby, particularly if there are no problems with the leakage paths. In particular the at least one fastening element can be located completely in a region formed by a common lateral recess in the printed-circuit board and cover, which will further reduce the installation space.

In another embodiment the cover is an annular cover and the at least one fastening element is secured on the outside of the annular cover.

Particularly in that case the projection can be an edge elevation formed by an outer wall of the annular cover. The edge elevation can extend in sections (segmentally) or completely around the outer wall's circumference.

The fastening element can be in particular a metallic fastening element.

The invention is described schematically in more detail in the following figures with the aid of exemplary embodiments. Elements that are the same or have the same effect may therein have been assigned the same reference numerals for the sake of clarity.

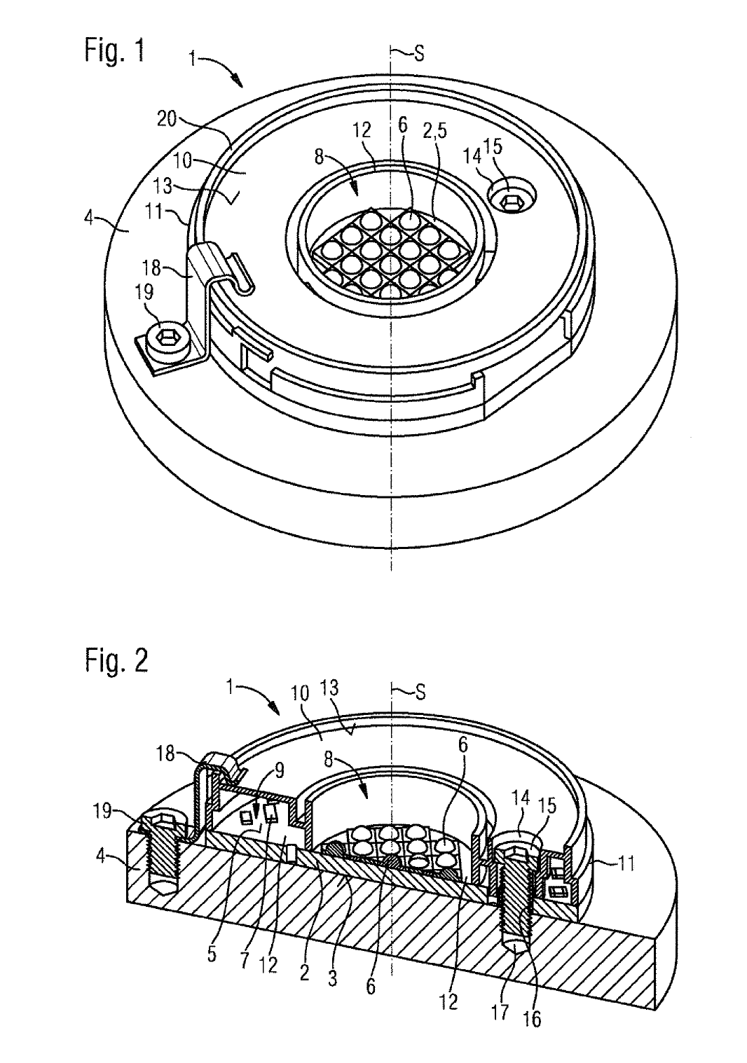

FIG. 1 is a view obliquely from the front or, as the case may be from above of an inventive lighting module according to a first embodiment variant;

FIG. 2 is a sectional representation, viewed obliquely from one side, of the lighting module according to the first embodiment variant;

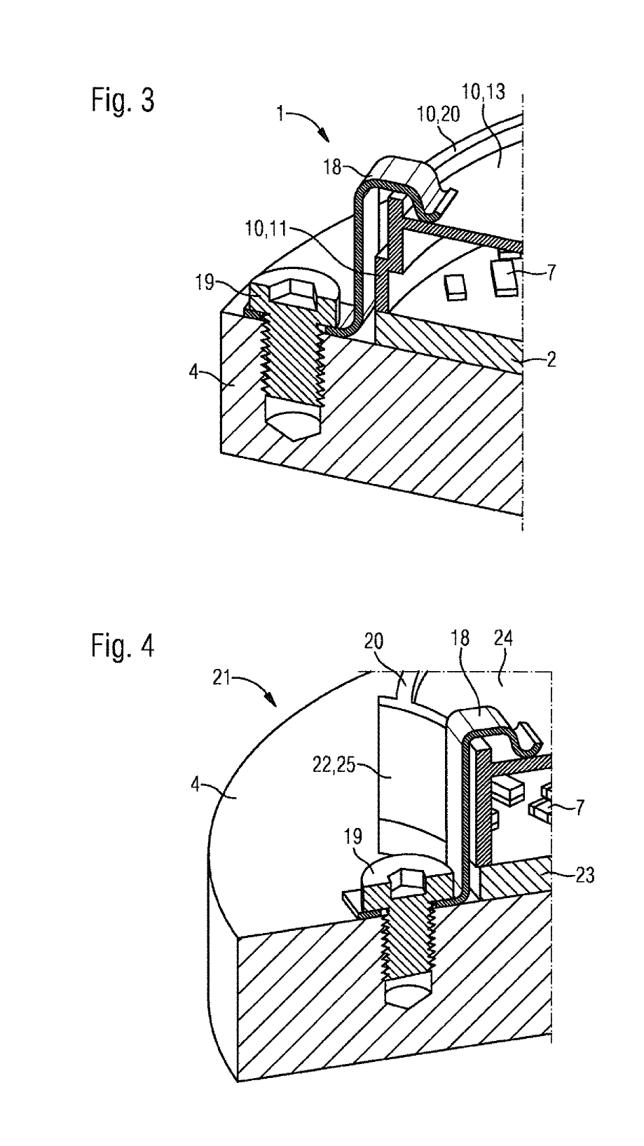

FIG. 3 shows a section from FIG. 2 in the region of an elastic fastening means;

FIG. 4 is a sectional representation, viewed obliquely from one side in the region of an elastic fastening means, of a lighting module according to a second embodiment variant; and

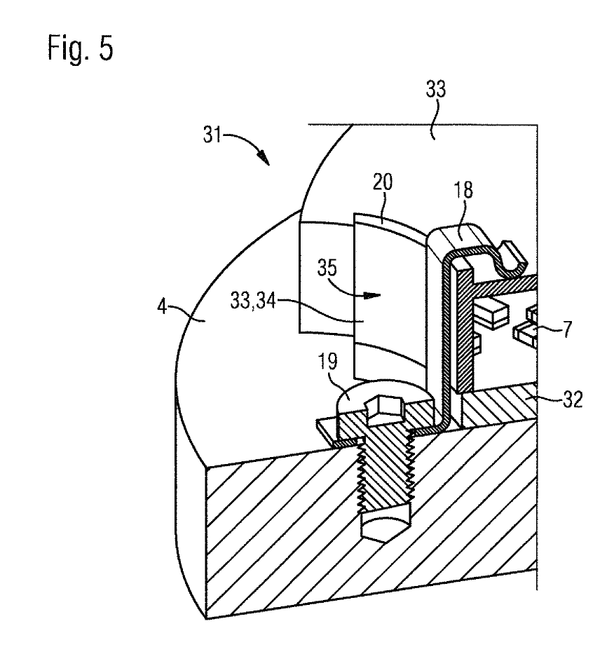

FIG. 5 is a sectional representation, viewed obliquely from one side in the region of an elastic fastening means, of a lighting module according to a third embodiment variant.

With reference to FIG. 1, FIG. 2, and FIG. 3, a lighting module 1 is shown that has a substantially circular-disc-shaped printed-circuit board 2 which via its rear side 3 is positioned on a cooling body 4 and on its front side 5 is fitted with a plurality of light sources in the form of light-emitting diodes 6 and a plurality of electronic components 7. Cooling body 4 is substantially basically cylindrical in shape. Light-emitting diodes 6 are arranged compactly in a central region 8 of printed-circuit board 2 and electronic components 7 are located in an annular ambient region 9 concentrically surrounding central region 8.

Ambient region 9 of printed-circuit board 2 is covered or, as the case may be, vaulted by an annular cover 10 that is open on its underside. Annular cover 10 has an outer wall 11 that is substantially hollow cylindrical in shape and an inner wall which is concentric to it and substantially hollow cylindrical in shape and has a smaller diameter. Outer wall 11 and inner wall 12 are joined by means of an annular, horizontally planar cover plate 13 or lid. Annular cover 10 has in other words a cross-sectional shape corresponding substantially to an upturned “U”. Annular cover 10 is seated on printed-circuit board 2, specifically such as to be externally flush with printed-circuit board 2. Inner wall 12 surrounds light-emitting diodes 6 and on its side facing light-emitting diodes 6 is embodied as a specular or diffuse reflector for forming a light channel for light-emitting diodes 6.

Annular cover 10 has a screw mount 14 for seating a screw 15, with screw 15 being fed though a lead-through opening 16 in printed-circuit board 2 into a screw hole 17 in cooling body 4 and there fixed into position. Tightening screw 15 causes annular cover 10 to be pulled against cooling body 4, thereby pressing printed-circuit board 2 into its fixed position between annular cover 10 and cooling body 4.

At a side that is opposite with respect to an axis of symmetry S, annular cover 10 is retained on the cooling body by means of an elastic fastening element 18. Fastening element 18 is embodied as a bent metal strip that is secured at one end region directly to cooling body 4 by means of a screw 19 and applied by its other end region against cover plate 13 of annular cover 10. Fastening element 18 is therein (pre-)tensioned so that it will press the annular cover onto printed-circuit board 2 under any thermal-stress conditions in order to suppress any mismatching due to fabrication tolerances, thermal losses, and ageing processes etc. Annular cover 10 can thus still be pressed onto printed-circuit board 2 even if screw 15 has expanded under a thermal load to such an extent that it no longer presses down on printed-circuit board 2.

In the first exemplary embodiment shown, outer wall 11 projects forward beyond cover plate 13 around its entire circumference. Even in a region in which it is vaulted by fastening element 18, annular cover 10 will thereby have an upward projection 20 (formed by the region—forwardly protruding beyond cover plate 13—of outer wall 11). Slipping of fastening element 18 away from annular cover 10 and vice versa can be prevented thereby.

FIG. 4 is a sectional representation, viewed obliquely from one side in the region of an elastic fastening means 18, of a lighting module 21 according to a second embodiment variant. Lighting module 21 corresponds to lighting module 1 except that fastening element 18 is now partially located in a region formed by a common lateral recess in printed-circuit board 23 and by annular cover 24. Expressed more precisely, outer wall 25 of annular cover 24 and printed-circuit board 23 have recess 22 whose outside is shaped like a hollow cylinder's longitudinal strip. A particularly compact lighting module 21 can be provided thereby.

FIG. 5 is a sectional representation, viewed obliquely from one side in the region of an elastic fastening means 18, of a lighting module 31 according to a third embodiment variant. Fastening element 18 is located completely in a region formed by a common lateral recess 35 in printed-circuit board 32 and outer wall 34 of cover 33. An even more compact lighting module 31 can be provided thereby. Outer wall 34 moreover projects only in the region of recess 35 in sections forwardly or, as the case may be, upwardly beyond cover plate 13.

The present invention is not, of course, limited to the exemplary embodiments shown.

### LIST OF REFERENCES

1 Lighting module
2 Printed-circuit board
3 Rear side of the printed-circuit board
4 Cooling body
5 Front side of the printed-circuit board
6 Light-emitting diode
7 Electronic component
8 Central region of the printed-circuit board
9 Ambient region of the printed-circuit board
10 Annular cover
11 Outer wall of the annular cover
12 Inner wall of the annular cover
13 Cover plate of the annular cover
14 Screw mount
15 Screw
16 Lead-through opening in the printed-circuit board
17 Screw hole
18 Securing element
19 Screw
20 Projection
21 Lighting module
22 Recess
23 Printed-circuit board
24 Annular cover
25 Outer wall of the annular cover
31 Lighting module
32 Printed-circuit board
33 Cover
34 Outer wall
35 Recess
S Axis of symmetry

1. A lighting module, comprising:
a printed-circuit board which via its rear side is positioned on a cooling body and on its front side is fitted with at least one light source, and at least one electronic component;
a cover for at least a partial region of the printed-circuit board, with the cover being seated upon the printed-circuit board;
wherein the lighting module has at least one elastic fastening element which is secured to the cooling body and positioned against the cover.

2. The lighting module as claimed in claim 1, wherein the cover has an outward projection at least in a region in which the cover is vaulted by the at least one fastening element.

3. The lighting module as claimed in claim 1,
wherein the at least one fastening element is kept under tension.

4. The lighting module as claimed in claim 1,
wherein the at least one fastening element is applied to a top side of the cover.

5. The lighting module as claimed in claim 1,
wherein the at least one fastening element is screwed onto the cooling body.

6. The lighting module as claimed in claim 1,
wherein the lighting module has a plurality of elastic fastening elements.

7. The lighting module as claimed in claim 1,
wherein the fastening element is located at least partially in a common lateral recess in the printed-circuit board and cover.

8. The lighting module as claimed in claim 7, wherein the at least one fastening element is located completely in a common lateral recess in the printed-circuit board and cover.

9. The lighting module as claimed in claim 1,
wherein the cover is an annular cover and the at least one fastening element is secured on the outside of the annular cover.

10. The lighting module as claimed in claim 2,
wherein the cover is an annular cover and the at least one fastening element is secured on the outside of the annular cover;
wherein the projection is an edge elevation formed by an outer wall of the annular cover.

11. The lighting module as claimed in claim 1,
wherein the at least one light source comprises a light-emitting diode

12. The lighting module as claimed in claim 2,
wherein the cover has an outward, upward projection.
